(19) United States
(12) Patent Application Publication
(10) Pub. No.: US 2013/0087176 A1
(43) Pub. Date: Apr. 11, 2013

(54) SYSTEM FOR SANITIZING SHOPPING CARTS

(71) Applicants: Douglas Wayne Sappington, Birmingham, AL (US); Robert Hugh Lee, Birmingham, AL (US)

(72) Inventors: Douglas Wayne Sappington, Birmingham, AL (US); Robert Hugh Lee, Birmingham, AL (US)

(73) Assignee: Oak Mountain Solutions, LLC, Biringham, AL (US)

(21) Appl. No.: 13/267,839

(22) Filed: Oct. 6, 2011

(51) Int. Cl. B08B 3/02; B08B 7/00

(52) U.S. Cl. 134/58 R; 134/123

(57) ABSTRACT

An apparatus and method is disclosed for systematically disinfecting shopping carts and other containers utilized in grocery stores by consumers to temporarily carry food items while shopping. The system consists of a hollow, inverted U-shaped housing that defines a cart passageway through which a shopping cart may be passed and disinfected. The system includes internal electrical elements, a fluid reservoir, a pump that pumps disinfecting fluid to several nozzles, a rechargeable battery, and is on wheels so that the system may be operated in an area of choosing independent from a power outlet. For disinfecting, carts are positioned in front of the cart passageway and pushed through while nozzles positioned in the cart passageway are actuated. A fine mist of disinfecting fluid envelopes all surfaces of the cart as it passes through the cart passageway, thereby sanitizing the entire surface area of the cart without accumulating residue.

This application claims the benefit of filing priority under 35 U.S.C. §119 and 37 C.F.R. §1.78 of the co-pending U.S. Provisional Application Ser. No. 61/404,684 filed Oct. 7, 2010, for a Santizit-Shopping Cart Sanitizing Spray Machine. All information disclosed in that prior pending provisional application is incorporated herein by reference.

### FIELD OF THE INVENTION

The present invention relates generally to washing and sanitizing systems. In greater particularity, the present invention relates to washing bays and car or automobile washing systems. In greater particularity, the present invention relates to disinfecting systems for articles placed into a controlled sanitizing area.

### BACKGROUND OF THE INVENTION

Our society is a mobile one. Travel from one country to another across multiple continents, sometimes in a single 24 hour period, is common place for human beings today. Infectious disease follow humans wherever they go and our societal mobility, while enhancing business and prosperity, brings with it the spread of disease across many time domains. While most diseases are spread with human to human contact or proximity, many diseases are also spread through germs acquired through contact surfaces. Consumers are rapidly becoming aware of this exposure threat.

During the last decade, consumers have watched as infectious diseases have sprung from Asia and quickly spread to other continents, mostly from people traveling for business and pleasure. Adding to this the increasing awareness of the historical effects of past influenza epidemics, pandemic illness outbreaks, and the current incurability of many human viruses, the current consuming public has become very aware of the potential for catching diseases from contact with germs. Videos of Asian populations wearing surgical masks in public such as in affluent Japan heighten the awareness. Hence, consumers now look for and routinely take advantage of antibacterial and anti-viral procedures available to them in retail store locations. Further, retail stores are taking active measures to reduce the spread of germs to consumers visiting their stores.

One area of significant concern is grocery outlets. A grocery outlet not only exposes consumers to human spread contagions, but food borne illnesses that are spread by germs are encountered throughout the entire store. Also, consumers use various styles of shopping carts such as a standard wheeled cart or a small hand basket and germs are spread to users through contact with the handles and surrounding structure of each cart or container. Shopping carts and hand baskets come into contact with more customers and more food products than any other area of a grocery store, and store customers generally do not clean their hands before utilizing shopping carts or hand baskets, and they do not wear protective gloves to shield themselves from exposure to the number of possible germs that may reside on the shopping cart or basket.

Grocery stores are aware of this concern by consumers. In response, the average grocery store may pressure wash carts and hand baskets with water (not killing any germs) periodically, say every 6 months or so. Because retail storeowners have needed to make some effort to address the concentration of germs on shopping carts and hand baskets, some stores have begun providing alcohol-based wipes and hand sanitizing liquid adjacent to the carts and baskets so that customers may attempt to address the germ problem themselves. The consumer can apply the hand sanitizer to their hands, before and after shopping, and they can use the alcohol wipes to disinfect shopping cart or basket surfaces. Unfortunately, alcohol wipes address only a small percentage of the contact potential of a cart surface, and there is no quality control as to how well or poorly a consumer might attempt to disinfect their hands or a cart surface.

Hence, what is needed is a system to efficiently and systematically sanitize grocery carts and baskets while avoiding inconvenience to consumers so that the risk of exposing customers to germs and disease during their shopping experience is avoided.

### SUMMARY OF THE INVENTION

An apparatus and method for systematically disinfecting shopping carts and other containers utilized in grocery stores by consumers to temporarily carry food items while shopping. The system consists of a hollow, inverted U-shaped enclosure or housing that defines a cart passageway through which a shopping cart may be passed and disinfected. The housing is hollow and contains a disinfecting liquid reservoir, a pump having a tube that is directed into the reservoir, a pressure accumulator, several nozzles arranged around the interior of the cart passageway, and some external controls to turn on the nozzles when a user pushes a cart into the disinfecting area. The system also includes a battery and charging system, and some control electronics, so that the system may be operated in an area of choosing independent from a power outlet. The bottom of the system includes wheels and a handle is attached to one end so that the system may be moved to any advantageous location within or without a store. The apparatus also includes a hand sprayer on one side so that a consumer or store employee may apply disinfectant on demand to specific areas of a cart or to a shopping basket. For disinfecting, carts are positioned in front of the cart opening in the housing and pushed through while the nozzles are actuated. A fine mist of disinfecting fluid envelopes all surfaces of the cart as it passes through the cart passageway, thereby sanitizing the entire surface area of the cart. Because the mist that is emitted from the apparatus nozzles is very fine, little or no residue accumulates on the carts or in the vicinity of the disinfecting apparatus.

Other features and objects and advantages of the present invention will become apparent from a reading of the following description as well as a study of the appended drawings.

### BRIEF DESCRIPTION OF THE DRAWINGS

A shopping cart disinfecting system incorporating the features of the invention is depicted in the attached drawings which form a portion of the disclosure and wherein:

FIG. 1 a front perspective view of the shopping cart disinfecting system showing its exterior;

FIG. 2A is a front view of the shopping cart disinfecting system;

FIG. 2B is a rear view of the shopping cart disinfecting system;

FIG. 2C is a left side view of the shopping cart disinfecting system;

FIG. 2D is a right side view of the shopping cart disinfecting system showing the positioning of the hand sprayer and external control elements;

FIG. 3 is a front perspective view having the front face of the invention removed to show key interior elements of the shopping cart disinfecting system;

FIG. 4A is a perspective interior view of the left access door in the open position;

FIG. 4B is a perspective interior view of the upper access door in the open position;

FIG. 4C is a magnified view of a spray nozzle tip in an access door;

FIG. 5 is a front view of the shopping cart disinfecting system showing the dynamics of sanitizing a shopping cart;

FIG. 6 is process flow diagram showing the steps in disinfecting one or more shopping carts using the described shopping cart disinfecting system.

### DESCRIPTION OF THE PREFERRED EMBODIMENTS

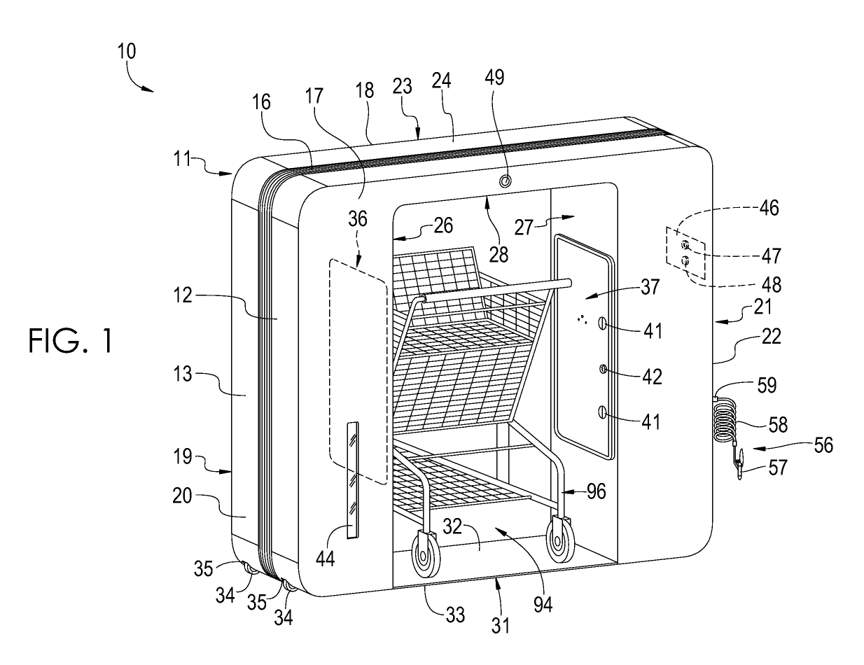

Referring to the drawings for a better understanding of the function and structure of the invention, FIG. 1 shows the system 10 ready for sanitizing shopping carts 96. The system 10 is comprised of a fiberglass shell or housing 11, hollow on the interior, and formed into an inverted U-shape. The fiberglass shell or housing 11 has a front 12 and rear 13 section joined together with a hard plastic molding 16. The joined sections form a front face or surface area 17, a rear facing surface area 18, left and right sides (19, 22) having left and right surface areas (20, 22), and a top or upper portion 23 with a top surface 24. The left 19, right 21 sides and the upper portion 23 connecting the two to form a bounded interior disinfection zone 94. The disinfection zone 94 has left and right surfaces (26, 27), and an upper surface area 28. Each of these surface areas includes an access door (36, 37, and 38) with hand laches 41, and the side access doors (36, 37) includes key access locks 42 as shown and as will be further described below. A level indicator window 44 is formed in front surface 17 to allow viewing of fluid levels in a disinfectant storage container inside housing 11. The underside of house 11 includes a base plate 31, having an upper surface 32 and an under surface 33.

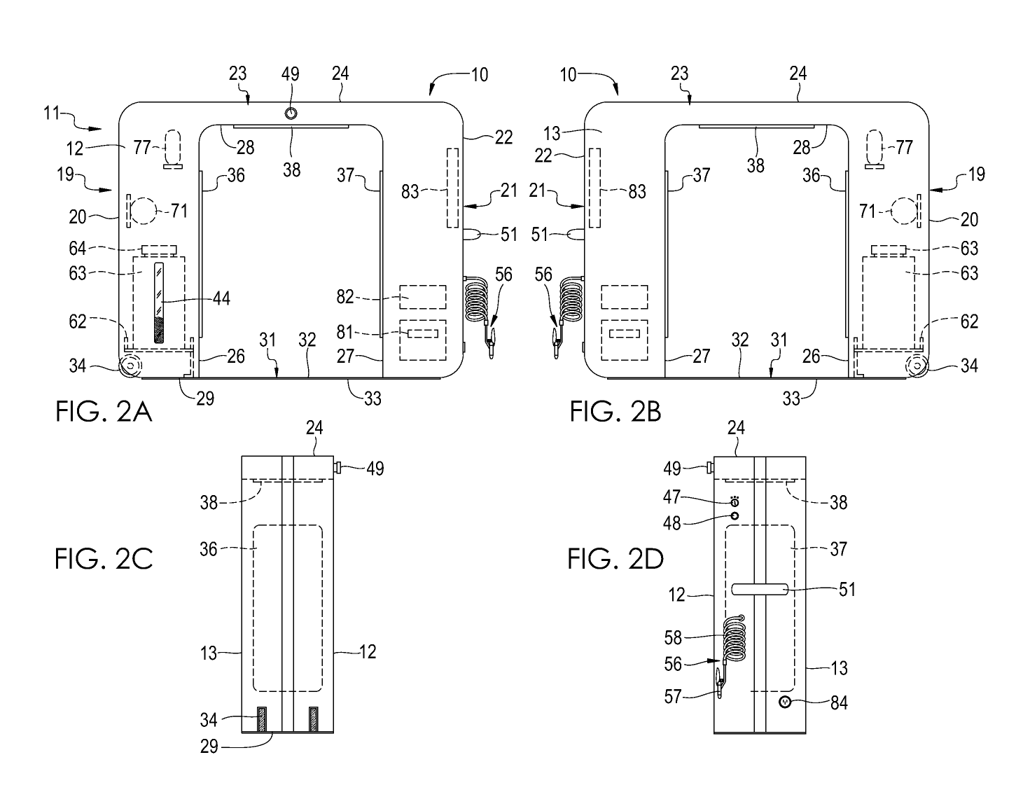

Referring now to FIGS. 2A-2D, it may be seen in 2A that the system has a front actuation button 49 for activating the system 10, and specifically initiating the spraying cycle. A pair of wheels are affixed to frame 62 within the left side 19 and extend through two slots 35 (FIG. 1) formed in housing 11 at the juncture of the lower edge of left side surface 20 and bottom surface 29 of housing left side 19. A countervailing handle 51 is affixed to right side surface 22 and upon the lifting of right side 21 wheels 34 will contact any ground surface supporting the system 10 and allow it to be easily moved and rotated as desired to reposition the system as needed. Wheels 34 are positioned on frame 62 such that the wheels do not contact the supporting ground until tilted by the lifting of opposite side end 21. Hence, the system 10 is very stable when resting in a horizontal position.

On the interior of left side 19 fluid tank 63 rests on frame 62 and frame 62 is sized to hold the tank securely. Window 44 allows for viewing of a graduated measuring scale formed in the front side of tank 63 which has a translucent exterior so that a user can see the amount of fluid left in tank 63.

On the interior of right side 21, system 10 includes a battery 81 and charger 82. Control panel 83 are connected to charger 82 and battery 81 to provide power to the system and to monitory and control the distribution of the power throughout the system 10 to power, for example, pump 71. The charger and battery are affixed directly to the fiberglass walls of housing 11 and need no separate support frame. Charger 82 is connected to power outlet 82 to allow for a plug and wire to connect system 10 with a standard household electrical outlet to charge battery 81. Access panel 46 defines control elements 47 a key switch and 48 a stop indicator light that are affixed to and extending through the right side surface 22. Stop indicator light 48 is used to advise the operator of warning conditions in the system 10, such as for example when fluid levels have dropped below a certain threshold inside tank 63. Key switch 47 it typically a 3 position switch providing for an off position and two operating modes for system 10.

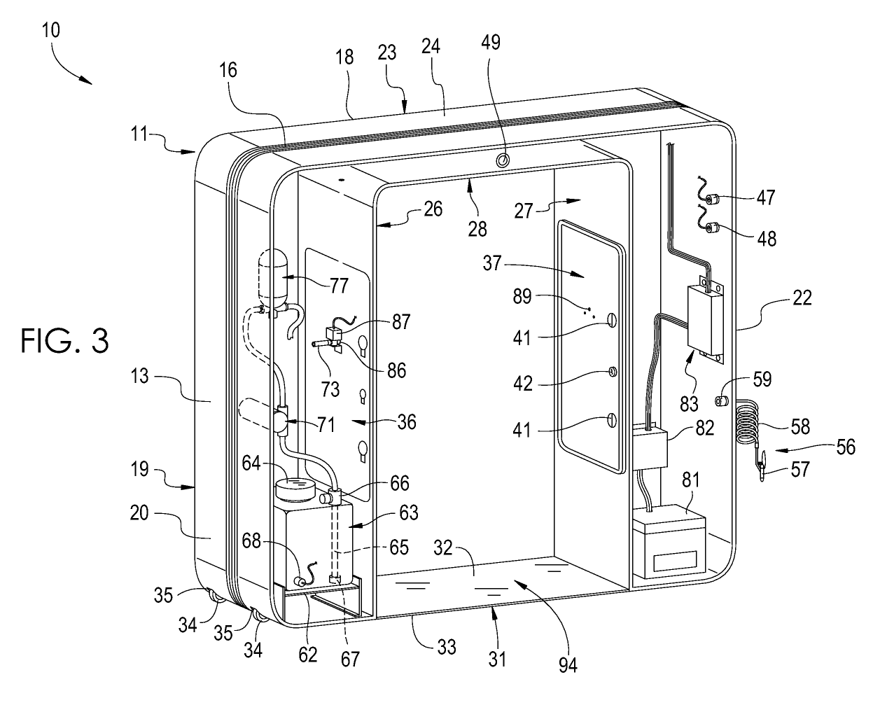

FIG. 3 shows a cut-away view of the system 10 showing key internal components. Tank 63 holds approximately 7 gallons of sanitizing fluid. Fluid is added to tank 63 by opening access door 36 and removing screw top lid 64. Filters 66, 67 are fixed to the top and bottom of tank fluid access riser tube 65 for keeping debris that enter into fluid tank 63 from being sucked into the internal fluid lines of the invention 10. A float sensor 68 is positioned in the bottom of tank 63 and provides a signal to control module 83 when the tank is empty forcing the suspension of pump operation until fluid is replaced in the tank 63. A network of fluid tubes travels throughout the inside of housing 11 to connect the tank 63, pump 71, accumulator 77 and nozzles 86. The tubing 73 is resilient enough to hold sanitizing fluid under at least 100 psi pressure for an extended period of time and includes connectors (not shown) for connecting the tubing 73 to the various internal components in the system. Nylon type tubes provide sufficient resiliency and durability to satisfy this requirement. Pump 71 can be a 12 Volt diaphragm type pump, such as manufactured by Shurflo Pump Manufacturing Co. of Cypress, Calif., under the name 8000 Series Diaphragm Pump. The pump 71 can produce 100 psi and 1.15 gallons per minute through lines 73, as needed, but typical flow rates are much less than 100 psi since spray nozzles 86 generally would not allow fluid to drain quickly enough for pump 71 to meet its flow rate upper limit. Tank accumulator 77, such as a model 181-201 type also available from Shurflo, keeps lines 73 under pressure within a typical range of 65-100 psi to each nozzle, but is also reduces the actuation load on pump 71 by allowing it to cycle on and off less frequently while still managing a maximum pressure of 100 psi and a minimum pressure of 65 psi, as directed by internal logic in the pump's electronics. Control module 83 is microprocessor controlled and provides power to operate pump 71 which maintains the pressure in lines 73 as described above. Control module 83 also is connected with wiring 76 to each solenoid 87 at each nozzle 86, start-stop switch 49, key control switch 47, as well as providing power to pump 71. Battery 81 provides power to control module 83, pump 71 (via module 83), and all control lines for switches and solenoids. Charger 82 is connected to an external plug 84 to provide 12 Volt power to battery 81 for its charging. The control module 83 may be re-programmed as needed to accommodate the various needs of a shopping venue and their employees. Further information regarding the type of microprocessor used in control module 83 and the firmware residing therein is omitted as such a control system and software is well understood in the industry and not necessary for a complete understanding of the herein described system.

Various types of sanitizing fluid may be used in system 10, but the inventors have found that a diluted solution of “66” manufactured by Staples Contract & Commercial (Product Item No. STP660001-B) works satisfactorily as a solution to be held by tank 63. The standard dilutions instructions that come with 66 and associated with this product will achieve satisfactory sanitization results when carts are sanitized in accordance with the herein provided methods.

Hand sanitizing sprayer 56 is positioned on the exterior of right side of the housing 11 and is connected by a coiled tube to tubing 73 via connector 59. The sprayer 56 is fluidly connected to accumulator 77 via fluid lines 73 such that between 65-100 psi fluid pressure is available at all times to the hand sprayer 56. When not in use, the handle of sprayer 56 may be loosely hooked onto mobility handle 51.

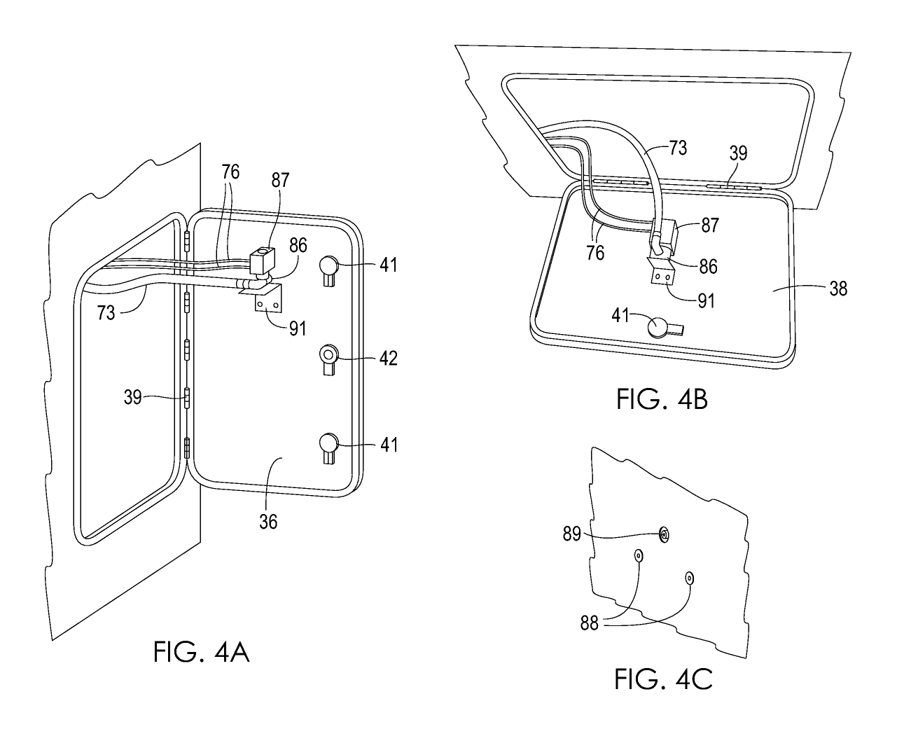

A closer view of the access doors of the system 10 and their elements may be seen in FIGS. 4A-4C. FIGS. 4A and 4B shows left access door 36 and upper access door 38 in their open positions, each held to interior surface of housing 11 with hinges 39. Right access door 37 is a mirror image of left access door 36. Each access door 36, 37, 38, includes a lock 42, and rotating plastic latches 41 to secure each access door in a closed position. Nozzles 86 are affixed on the interior of each access door and positioned with tips 89 penetrating through the composite plastic of each doors' surface (see FIG. 4C). Solenoids 87 are positioned adjacent to each nozzle 86 to control the flow of sanitizing fluid to each nozzle. A tube 73 connects each nozzle to accumulator tank 77 and electrical wiring 76 operatively connects each solenoid to control module 83. A small bracket 91 is riveted 88 (See FIG. 4C) to the surface of each door and holds each nozzle and solenoid in place. By placing a spray nozzle 86 in each access door, cart passageway or cart disinfecting zone 94 is surrounded by three intersecting spray patters such that each cart passing through the zone 94 will have 100 percent of its surface areas covered by sanitizing fluid.

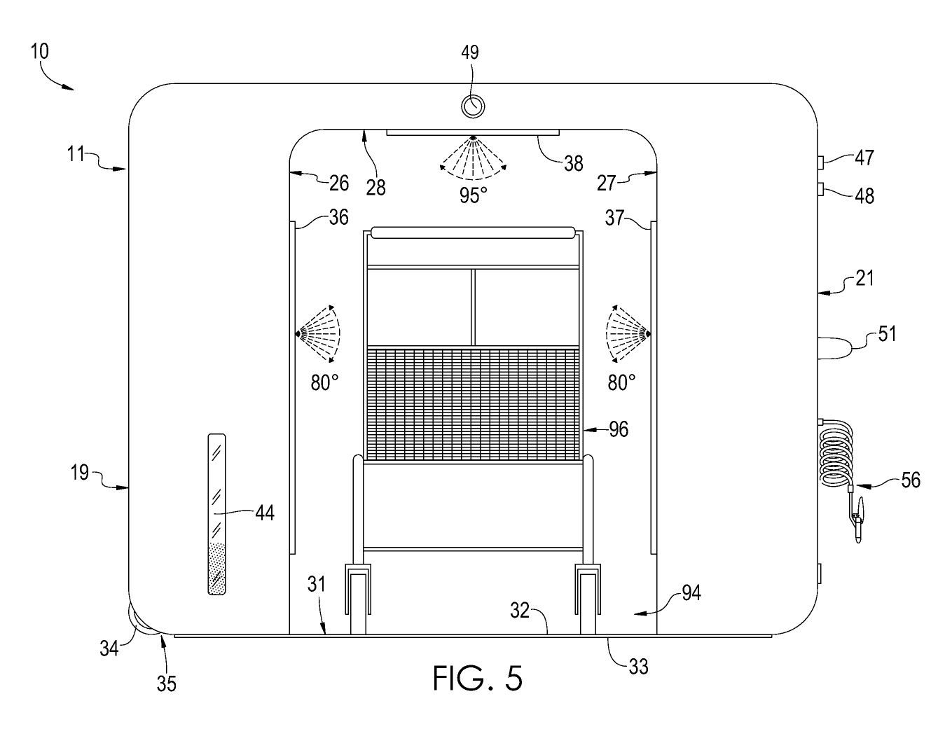

The dynamics of sanitizing a cart 96 may be seen in FIG. 5. As discussed previously, nozzles 86 are positioned around cart passageway 94 to create a disinfection zone when solenoids actuate nozzles 86. Accumulator tank 77 maintains a pressure of between 65 and 100 psi inside all hoses or tubing 73 that connects each spray nozzle 86 to accumulator 77. Spray nozzle 86 positioned in upper access door 38 is configured to provide a fan type spray pattern with a dispersion angle of 95 degrees. At between 65 and 100 psi, nozzle 86 in door 38 will provide an approximate flow volume of between 0.040 and 0.052 gallons per minute, at a maximum particle size of approximately 175 microns. Left 36 and right 37 access door nozzles 86 are also configured to provide a fan type spray pattern with a dispersion angle of 80 degrees. At between 65 and 100 psi, nozzles 86 in left and right access doors provide an approximate flow volume of between 0.031 and 0.040 gallons per minute, at a maximum particle size of approximately 150 microns. The inventors have found that the optimal speed of causing a shopping cart to pass through the sanitization zone 94 is one foot per second at these spray rates. The configuration and placement of the spray nozzles 86 around the disinfection zone 94, at the above specified flow and particle sizes, and speeds, allows for maximum surface coverage of a shopping surface when caused to pass through the zone 94.

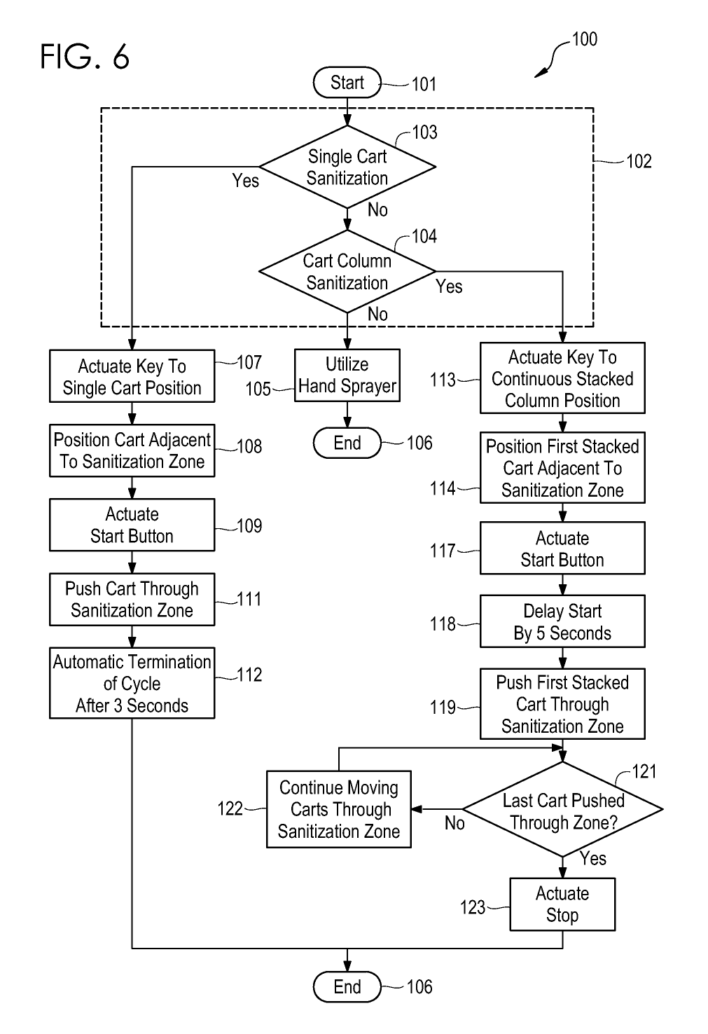

Referring now to FIG. 6, it may be seen that three principle modes are utilized in system 10 in sanitizing a shopping cart or basket, as shown in block 102. After initiating the system, the system 10 will either be used to sanitize a single cart 103, or used to sanitize an entire collapsed or folded cart column 104. A cart column is a series of shopping carts grouped and engaged into an interlocking and stacked configuration to save space, as is known by any grocery worker. If neither of these cart configurations is to be sanitized by the system 10, then the hand sprayer 56 is to be used 105 to sanitize either a single cart or other carrying container, such as a hand basket.

If a single cart is to be sanitized, three position key switch 47 is turned to the appropriate mode 107 and the cart is positioned 108 adjacent to the sanitization zone 94. Start-stop button 49 is then depressed 109 to activate solenoids 87 which initiates spray from nozzles 86 into zone 94. The cart is then pushed through the sanitization zone 94 at approximately 1 foot per second speed 111. As the cart is passes through the zone, all surface areas will be covered and sanitized. Control module 83 keeps track of the expended flow time during fluid release and shuts off each spray nozzle 86 via solenoids 87 after three seconds have elapsed 112. After the cart has passed through the zone 94, the cycle ends 106.

A cart column can also be sanitized with equally successful results. If a column is to be sanitized 104, key switch 47 is turned to a continuous or column mode 113. The stacked carts are then moved 114 such the first cart is adjacent to the sanitation zone 94. The start-stop button 49 is depressed and the solenoids are opened after a 5 second delay 118 and the nozzles then begin to spray fluid. The first stacked cart is then pushed through the sanitization zone and the entire cart column moved at approximately 1 foot per second through the cart passageway or zone 94 until all of the carts have been moved through the system 121-122. After the last cart has been pushed through, the key switch 47 is rotated to its off position to turn off system 10 or the start-stop button is again depressed to stop the cycle 123. Start-stop button 47 may be repeatedly depressed to toggle on and off the spray nozzles as needed to position and re-position stacked carts through the sanitization zone 94. This ends the stacked column sanitization process.

While I have shown my invention in one form, it will be obvious to those skilled in the art that it is not so limited but is susceptible of various changes and modifications without departing from the spirit thereof. For example, the inventors contemplate that the system would be used for articles different than shopping carts and baskets, such as for example wheel chairs, hand carts, and baby strollers. To that end, the firmware in controller 83 can be adjusted to control the functioning (e.g. timing) of the nozzles and the positioning of the nozzles can be easily altered to suit different sizes of articles.

Having set forth the nature of the invention, what is claimed is:

1. A shopping cart sanitizing system, comprising:
a. an inverted U-shaped housing;
b. said interior of said U-shaped housing defining a sanitization zone for pushing carts therethrough;
c. at least one spray nozzle positioned on the interior of said U-shaped housing, said nozzle adapted to cover the exterior of said shopping cart with sanitization fluid upon the passage of said cart through said sanitization zone;
d. a reservoir operatively connected to said spray nozzle and connected to said housing for holding sanitizing fluid;
e. a pump operatively connected to said at least one spray nozzle and connected to said U-shaped housing for transferring sanitizing fluid from said reservoir to said at least one spray nozzle; and,
f. a power and control system affixed to said housing for initiating and powering said pump.

2. The cart sanitizing system of claim 1, further including three nozzles positioned within said sanitization zone and wherein two of said nozzles stream fluid at an 80 degree angle and said third nozzle streams fluid at a 95 degree angle to ensure complete coverage of said shopping cart with fluid.

3. The cart sanitizing system of claim 2, further including solenoids connected to each said at least one nozzle and electrically connected with said power and control system for controlling the dispensing of fluid from each said nozzle.

4. The cart sanitizing system of claim 3, further including wheels on the underside of said housing for moving said cart sanitizing system and wherein said pump, battery, and nozzles are positioned within the interior of said housing.

5. The cart sanitizing system of claim 4, wherein said power and control system includes a battery and battery charger for powering said pump.

6. The cart sanitizing system of claim 5, further including a hand sprayer on the exterior of said housing and operatively connected to said pump.

7. The cart sanitizing system of claim 6, wherein each said spray nozzle produces a minimum flow volume of 0.04 gallons per minute at 100 pounds per square inch.

8. The cart sanitizing system of claim 1, further including wheels on the underside of said housing for moving said cart sanitizing system and wherein said pump, battery, and nozzles are positioned within said housing.

9. The cart sanitizing system of claim 8, further including a hand sprayer on the exterior of said housing and operatively connected to said pump.

10. The cart sanitizing system of claim 9, wherein said power and control system includes a battery and battery charger for powering said pump.

11. The cart sanitizing system of claim 1, further including at least one wheel positioned under one arm of said inverted U-shaped housing and a handle positioned on the exterior of said other arm of said inverted U-shaped housing to allow easy repositioning of said sanitizing system.

12. The cart sanitizing system of claim 11, further including a base plate affixed to the underside of said inverted U-shaped housing for stabilizing said same.

13. The cart sanitizing system of claim 12, wherein each said at least one spray nozzle produces a minimum flow volume of 0.04 gallons per minute at 100 pounds per square inch.

14. A method for sanitizing shopping carts using a sanitizing apparatus having an inverted U-shaped housing, a cart passageway in the interior of said U-shaped housing sized to accommodate the passage of a shopping cart, and a plurality of spray nozzles positioned to spray sanitizing fluid throughout the cart passageway while a cart passes therethrough, said method comprising the steps of:
a. positioning a shopping cart adjacent to said passageway;
b. electronically initiating the sanitizing apparatus;
c. causing the dispensing of sanitizing fluid from said spray nozzles;
d. causing the shopping cart to pass through said passageway such that the cart is covered with sanitizing fluid;
e. causing the cart to exit said passageway; and,
f. ceasing fluid dispensing.

15. The method according to claim 14, wherein said sanitizing fluid remains on said shopping cart for a minimum of 20 seconds.

16. The method according to claim 15, wherein said step of dispensing of sanitizing fluid from said spray nozzles further comprises dispensing said fluid with a maximum fluid particle size of 175 microns.

17. The method according to claim 14, wherein said step of dispensing of sanitizing fluid from said spray nozzles further comprises dispensing said fluid with a maximum fluid particle size of 175 microns.

18. A shopping cart sanitization system, comprising:
a. a housing having two upstanding sides connected at their tops by an upper portion, the interior of said housing being hollow;
b. said two sides and upper portion defining an open area sized for the passage of a shopping cart therethrough;
c. a reservoir positioned inside said housing for holding sanitizing fluid;
d. a plurality of nozzles connected to said reservoir and positioned to spray fluid into said open area;
e. a pump positioned inside said housing for pumping fluid from said reservoir to said nozzles;
f. a rechargeable power system inside said housing for powering said sanitization system; and,
g. a control system for controlling the initiation and duration of said nozzles spraying fluid into said open area onto a shopping cart passing therethrough.

19. The cart sanitizing system of claim 18, where said plurality of nozzles comprises three nozzles, one positioned on said upper portion of said housing and configured to provide a fan spray angle of 95 degrees and the others positioned on said two sides of said housing each configured to provide a fan spray angle of 80 degrees.

20. The cart sanitizing system of claim 19, further including at least one wheel positioned under one side of said housing and a handle positioned on the exterior of said other side of said housing to allow easy repositioning of said sanitizing system.

21. The cart sanitizing system of claim 20, further including a hand sprayer on the exterior of said housing and operatively connected to said pump.

22. The cart sanitizing system of claim 18, further including at least one wheel positioned under one side of said housing and a handle positioned on the exterior of said other side of said housing to allow easy repositioning of said sanitizing system.

23. The cart sanitizing system of claim 22, further including a hand sprayer on the exterior of said housing and operatively connected to said pump.
